(19) United States
(12) Patent Application Publication
(10) Pub. No.: US 2013/0080402 A1
(43) Pub. Date: Mar. 28, 2013

(54) METHOD AND SYSTEM FOR VEHICLE ON-BOARD PARAMETER VALIDATION

(71) Applicants: John G. Bate, Oak Ridge, NC (US); Raymond A Gardea, Winston-Salem, NC (US); James R. Gwynn, Greensboro, NC (US); Helmut Guehr, JR., Winston-Salem, NC (US)

(72) Inventors: John G. Bate, Oak Ridge, NC (US); Raymond A Gardea, Winston-Salem, NC (US); James R. Gwynn, Greensboro, NC (US); Helmut Guehr, JR., Winston-Salem, NC (US)

(73) Assignee: VOLVO GROUP NORTH AMERICA, LLC, Greensboro, NC (US)

(21) Appl. No.: 13/698,404

(22) PCT Filed: Jul. 20, 2010
(86) PCT No.: PCT/US10/42576

§ 371 Date: Nov. 16, 2012

(51) Int. Cl. G06F 17/30

(52) U.S. Cl. CPC G06F 17/30943
USPC 707/690

(57) ABSTRACT

A system and method for validating data stored in one or more vehicle electronic units includes confirming that a data validation package is present in a first electronic control unit on-board the vehicle, comparing data in the validation package to data stored by at least one target electronic control unit on-board the vehicle, logging any discrepancies between the data in the validation package and the data stored by the at least one target electronic control unit, and wirelessly transmitting a message from the first electronic control unit identifying any discrepancies in the data stored by the at least one electronic control unit to a remote location.

### FIELD OF THE INVENTION

The invention relates to electronic control systems for vehicles, and more particularly, to a system and method for validating the parameters stored and used by a vehicle electronic control system.

### BACKGROUND AND SUMMARY

Electronic control units (ECU) on vehicles, for example, an engine ECU, instrument cluster ECU, and vehicle ECU, have stored data parameters used to control various vehicle functions. For example, the engine ECU may contain data for applying speed limits to the vehicle for reasons of fuel economy, engine wear, or other reasons. If the parameter is altered, the fuel economy may be negatively affected, and the owner of the vehicle may have no knowledge if the alteration was unauthorized.

Known systems for verifying data stored in on-board ECUs require physical contact, for example, a plug-in device that downloads data from the various on-board ECUs for inspection. This requires the vehicle to travel to a maintenance location, or a device brought to the vehicle, either of which is a disadvantage. Another disadvantage is that a plug-in device can interrogate only the vehicle to which it is plugged in, that is, one vehicle at a time.

The invention provides a system and method for performing parameter or data validation by an on-board ECU on the data stored in a vehicle's ECUs. The invention has the advantages of remote operation and the ability to initiate the validation process on multiple vehicles simultaneously.

According to the invention, a user, who can be a fleet operator, operating remotely from the vehicle, for example, at a back office system, selects the feature or features to be validated on a truck or trucks. A validation package, containing the data or parameters to be verified, is built from a database at the back office. The data validation package contains data on at least one vehicle function parameter from a plurality of vehicle function parameters.

The validation package may be compressed and encrypted before transmission, and is transmitted to each vehicle which will perform the validation process. If encrypted, the system on-board the vehicle receiving the validation package will have a key for decrypting the package. The vehicle (or vehicles) receives the validation package and stores it on-board in a memory device. The validation package contains the information allowing the on-board ECU to compare the contents of the package with the data stored by the target or subject on-board ECUs.

The method includes the steps of receiving in an electronic control unit on-board a vehicle a data validation package from a remote source and storing the validation package in memory.

The validation procedure may be initiated by a vehicle ignition key-on, that is, when the vehicle is powered to start the engine, or some other event. An advantage of the invention is that the validation procedure can be run repeatedly without bringing the vehicle to a maintenance facility.

A method, according to the invention, for validating data stored in a vehicle electronic control system, includes the steps of confirming that a data validation package is present in a first electronic control unit on-board the vehicle, comparing data in the validation package to data stored by at least one target electronic control unit on-board the vehicle, logging any discrepancies between the data in the validation package and the data stored by the at least one target electronic control unit, and, transmitting wirelessly a message from the first electronic control unit identifying any discrepancies in the data stored by the at least one electronic control unit to a remote location.

According to another aspect of the invention, the method includes the step of replacing data stored by the at least one electronic control unit identified as having a discrepancy with data from the validation package.

According to yet another aspect of the invention, the step of comparing data in the validation package to data stored by at least one electronic control unit on-board the vehicle compares data stored in at least one of an engine electronic control unit, a vehicle electronic control unit, and an instrument cluster electronic control unit.

According to another aspect of the invention, the method includes the step of reading data from the target electronic control unit into a memory of the first electronic control unit before the step of comparing data to the validation package data is performed.

### BRIEF DESCRIPTION OF THE DRAWINGS

The invention will be better understood with reference to the following detailed description read in conjunction with the appended drawings, in which:

FIG. 1 is a schematic drawing of a system in accordance with the invention;

FIG. 2 is a schematic drawing of an on-board system in accordance with the invention; and,

FIG. 3 is a flow diagram of one embodiment of a method in accordance with the invention.

### DETAILED DESCRIPTION

The system and method for validating the data in one or more vehicle electronic control units (ECUs), includes a system and method for remotely communicating with the vehicle and a system and method on-board the vehicle. The invention is applicable to vehicles, and the following description is directed to heavy trucks and heavy truck fleets, for which the method and system are advantageous. This description is not meant to be limiting, however. The invention is suited for use with other vehicles which an owner may want to monitor, such as taxi cabs, delivery trucks, trash haul trucks, or car pools.

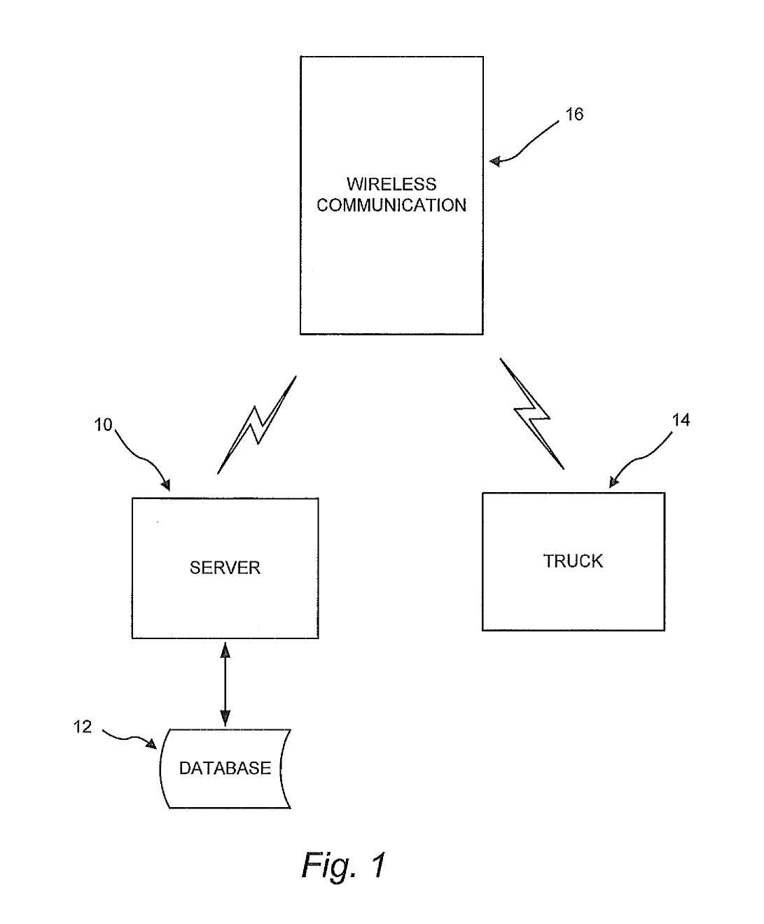

FIG. 1 illustrates an exemplary system for communicating with one or more trucks. A back office server 10 is connected to or includes a database 12 of the data stored on the various ECUs on the truck. The server 10, through an appropriate transmitter (not illustrated) can communicate with a truck or many trucks 14 over a wireless network 16. The network may include a satellite link, cellular telephone link, wireless Internet link, or other suitable communications link.

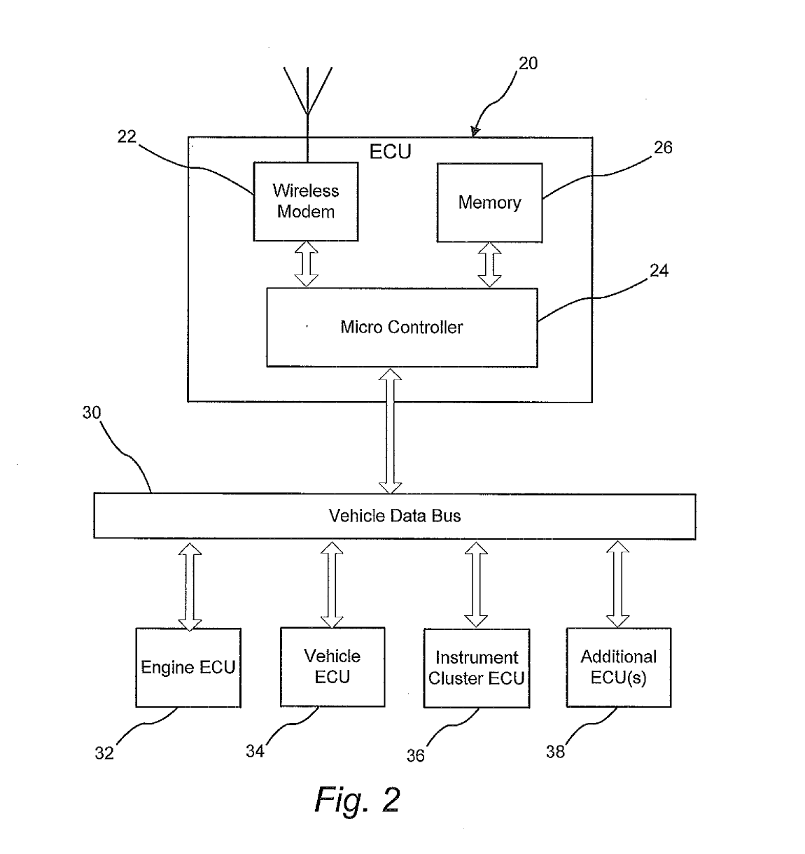

FIG. 2 illustrates an embodiment of a system according to the invention located on-board a vehicle. Each vehicle for which the method is to be performed will include the on-board system. The truck has an ECU 20 configured to perform the method of the invention. The ECU may be one dedicated for the validation method, for example, a telematics unit, or one of the on-board ECUs, for example, the Vehicle ECU, specially configured to perform the method. The ECU 20, hereinafter, the validating ECU, includes a transceiver 22 to communicate over a wireless network such as that described in connection with FIG. 1. The ECU 20 also includes a microprocessor controller 24 and a memory 26. Examples of microprocessor controllers that may be used in the system include various ARM (Advanced RISC Machine) processors, such as ARM 7, ARM 9, etc., from various manufacturers (IBM, Intel, Texas Instruments, etc.). Other microprocessors such as from the Intel 80186 family, or others may also be suitable.

The microprocessor controller 24 is connected to the vehicle data bus 30 to communicate with the various vehicle ECUs. FIG. 2 illustrates, as an example, an engine ECU 32, a vehicle ECU 34, an instrument cluster ECU 36, and an additional ECU 38. The additional ECU 38 may be a transmission ECU, a brake ECU, or a body control ECU, for example.

A system user, for example, a truck fleet owner or manager, accesses the back office server and selects a truck function to be validated. The function may be, for example, a speed limiter, idle control, or other function that may be tampered with. Alternatively, two or more functions may be selected. The server 10 (FIG. 1) accesses the database 12 and builds a validation package consisting of the correct data that should be stored on the appropriate truck ECU. The server 10 prepares the validation package for transmission to the truck or trucks, and may compress and encrypt it. The validation package is transmitted over the wireless network 16 to the selected truck or trucks 14.

The validating ECU's transceiver 22 on each truck selected for on-board data validation receives the validation package and the microprocessor controller 24 stores the validation package in memory 26. If the validation package was transmitted in encrypted form, the microprocessor controller 24 will have a key or password that decrypts the package. The validation package will include the correct ECU data to be compared to the data stored in the on-board ECUs. The validation package or may also include an initiation instruction for the process, such as an instruction to run the validation procedure at each key-on. Other initiation instructions may be used, for example, at a selected time of day. Alternatively, the validating ECU may have the initiation instruction stored in memory along with an instruction set for performing the validation procedure.

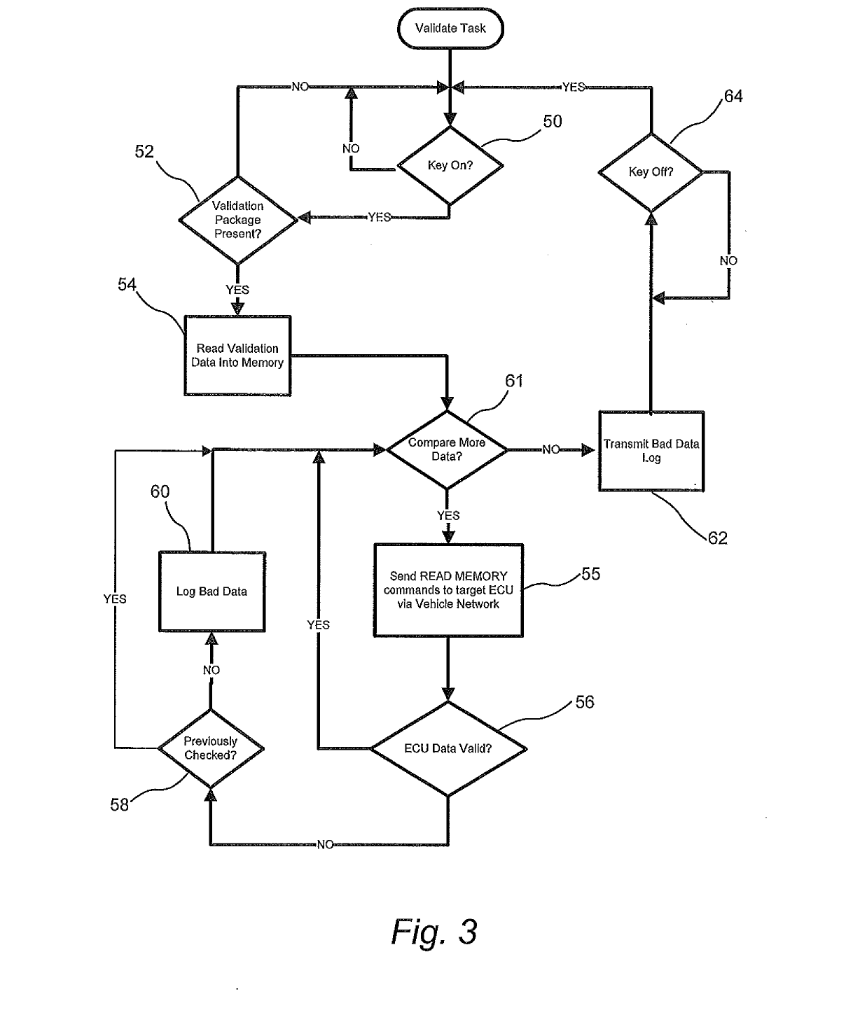

Referring now to FIG. 3, when the process is initiated at ignition key-on (step 50) or another initiating instruction the validating ECU 20 first checks (step 52) that a validation package is present in the memory 26. The initiation instruction is preferably an ignition key-on. Alternatively, the initiation instruction may be a command received from a remote source (e.g., from a back office), the vehicle's crossing a geofence or arrival at a selected location (signaled, for example, by aid of a GPS device), an internal timer signaling the expiration of a time period or the occurrence of a time and date, or some other instruction. If a validation package is present, the procedure is initiated. If no validation package is present, the validating ECU continues to wait to receive a validation package.

Once initiated, the validating ECU reads data from the subject ECUs and stores it in the memory 26 (step 54). This may be done by way of an instruction (step 55), a READ MEMORY packet, sent over the vehicle data bus from the validating ECU to the subject ECU. The validating ECU compares the data read from each subject ECU to the correct data received from the server (step 56). Any discrepancies are compared to an error log to determine if the discrepancy has been previously identified (step 58). If there is no record, the discrepancy is logged into the error log, along with the time and date (step 60). The validating ECU continues checks for additional data to read (step 61) and continues to compare the read-in data to the correct data and to log discrepancies until all the data has been checked.

Each ECU to be inspected is checked in a similar manner. When all ECUs have been checked and any error logs assembled, the validating ECU prepares and sends a message to the back office server if there are any error logs (step 62).

At vehicle key-off, the system shuts down and waits for the next ignition key-on (or other initiating event) to initiate the procedure again (step 64).

As additional steps, the validating ECU may re-write the data found to have errors, that is, replace the data found to be faulty with the correct data from the validation package, and verify that the correct data was stored. The error log sent to the back office would include a message that the faulty data was corrected.

The invention has been described in terms of preferred principles, embodiments, and components; however, those skilled in the art will recognize that substitutions may be made without departing from the scope of the invention defined by the appended claims.

What is claimed is:

1. A method for validating data stored in a vehicle electronic control system, comprising the steps of:
confirming that a data validation package is present in a first electronic control unit on-board the vehicle;
comparing data in the validation package to data stored by at least one target electronic control unit on-board the vehicle;
logging any discrepancies between the data in the validation package and the data stored by the at least one target electronic control unit; and,
transmitting wirelessly a message from the first electronic control unit identifying any discrepancies in the data stored by the at least one electronic control unit to a remote location.

2. The method of claim 1, further comprising the step of replacing data stored by the at least one electronic control unit identified as having a discrepancy with data from the validation package.

3. The method of claim 1, wherein the step of comparing data in the validation package to data stored by at least one electronic control unit on-board the vehicle compares data stored in at least one of an engine electronic control unit, a vehicle electronic control unit, and an instrument cluster electronic control unit.

4. The method of claim 1, further comprising commencing the confirming step upon detecting an initiating event.

5. The method of claim 4, wherein the initiating event is a vehicle ignition key-on.

6. The method of claim 1, wherein the data validation package contains data on at least one vehicle function parameter from a plurality of vehicle function parameters.

7. The method of claim 1, further comprising the steps of:
receiving in an electronic control unit on-board a vehicle a data validation package from a remote source; and,
storing the validation package in memory.

8. The method of claim 1, further comprising the step of reading data from the target electronic control unit into a memory of the first electronic control unit.
